(19) United States
(12) Patent Application Publication
(10) Pub. No.: US 2011/0194068 A1
(43) Pub. Date: Aug. 11, 2011

(54) V-Shape Progressive Lens Design

(75) Inventors: Ronald D. Blum, Roanoke, VA (US); Amitava Gupta, Roanoke, VA (US); Dani Katzman, Givat Ela (IL)

(73) Assignee: PixelOptics, Inc., Roanoke, VA (US)

(21) Appl. No.: 12/964,368

(22) Filed: Dec. 9, 2010

Related U.S. Application Data
(60) Provisional application No. 61/285,370, filed on Dec. 10, 2009.

(51) Int. Cl. G02C 7/06

(52) U.S. Cl. 351/169

(57) ABSTRACT

Progressive lens designs are provided with various features relative to the corridor width, corridor length, and relative positioning of areas of maximum gradient power progression and maximum gradient, that differ from conventional progressive lens designs. Progressive lenses according to the invention may include a “V-shaped” cylinder map, a relatively low position of maximum gradient of power progression, and/or a large vertical separation between vertical position of maximal cylinder and vertical position of maximum gradient of power progression.

### CROSS-REFERENCES TO RELATED APPLICATIONS

This application claims the benefit under 35 USC 119(e) to provisional application Ser. No. 61/285,370 filed Dec. 10, 2009, the contents of which are incorporated herein by reference in their entirety.

### SUMMARY OF THE INVENTION

According to an aspect of the present invention, a progressive lens design provides improved performance over conventional progressive lens designs. According to various concepts described herein, exemplary embodiments of the invention may include a “V-shaped” cylinder map, a relatively low position of maximum gradient of power progression, and/or a large vertical separation between vertical position of maximal cylinder and vertical position of maximum gradient of power progression.

Embodiments of the invention may include a progressive lens including a progressive add zone and a corridor width including a horizontal length between two points at the same vertical position where the cylinder astigmatism is approximately 0.75 D. In embodiments, a cylinder map of the lens may include a plurality of vertically separated corridor widths forming a substantially v-shaped corridor between the cylinder astigmatism of approximately 0.75 D.

In embodiments, the v-shaped corridor may be in a lower 50% of the lens. According to other embodiments, the corridor widths of the v-shaped corridor may include at least a first width extending approximately from −10 degrees to 10 degrees, and a second width extending approximately from −6 degrees to 0 degrees, on the cylinder map.

According to other aspects of the invention, embodiments may include a progressive lens with a progressive add zone and a corridor length including a length between a fitting point and a vertical position of at least one of a near measuring point and a point where full addition is reached. In embodiments, an addition gradient map of the lens may include a maximum gradient of power progression in a lower half of a corridor length.

In embodiments, the maximum gradient of power progression may be in a lower third of the corridor length. In embodiments, the corridor length may be approximately 30 degrees and the maximum gradient of power progression may be located at approximately 20 degrees below the fitting point.

According to yet further aspects of the invention, embodiments may include a progressive lens with a progressive add zone and a corridor length including a length between a fitting point and a vertical position of at least one of a near measuring point and a point where full addition is reached. In embodiments, a comparison between a cylinder map of the lens and an addition gradient map of the lens may indicate a vertical separation between a vertical position of maximal cylinder and a vertical position of maximum gradient of power progression, the vertical separation being greater than 20% of the corridor length.

In embodiments, the vertical separation may be approximately 30% of the corridor length. In embodiments, the corridor length may be approximately 30 degrees and the vertical separation may be approximately 10 degrees.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 depicts aspects of an exemplary lens according to an embodiment of the invention.

FIG. 2 is a cylinder map depicting further aspects of an exemplary lens according to an embodiment of the invention.

FIG. 3 is a graph depicting details regarding the gradient of power progression of an exemplary lens according to an embodiment of the invention.

FIG. 4 is a addition gradient map depicting further aspects of an exemplary lens according to an embodiment of the invention.

FIG. 5 is a combination of the cylinder map of FIG. 2 and the addition gradient map of FIG. 4 depicting further aspects of an exemplary lens according to an embodiment of the invention.

### DETAILED DESCRIPTION OF THE INVENTION

It is understood that the invention is not limited to the particular methodology, protocols, and reagents, etc., described herein, as these may vary as the skilled artisan will recognize. It is also to be understood that the terminology used herein is used for the purpose of describing particular embodiments only, and is not intended to limit the scope of the invention. It also is be noted that as used herein and in the appended claims, the singular forms “a,” “an,” and “the” include the plural reference unless the context clearly dictates otherwise.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

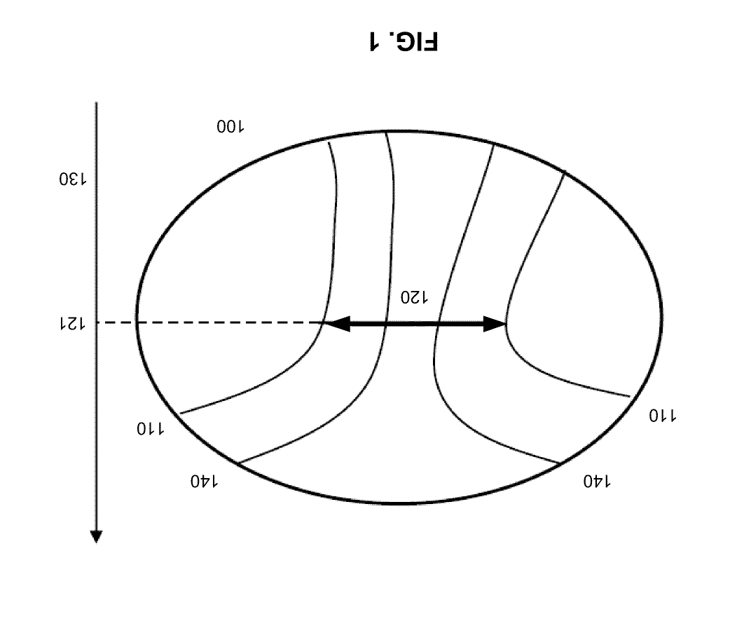

The corridor width of a progressive lens is generally defined as the horizontal length (typically expressed as a spatial or angular quantity) between two points at the same vertical position where the cylinder astigmatism reaches a given value, e.g. 0.75 D. Corridor width is generally a function of vertical position. An example corridor width measurement is shown in FIG. 1.

As shown in FIG. 1, a lens 100 has a corridor width 120, at a vertical position 121, between lines 110 representing a cylinder astigmatism of 0.75 D. The vertical position is measured with respect to line 130, and lines 140 represent a cylinder astigmatism of 0.25 D

The corridor length of a progressive lens is generally defined as the length between the fitting point and the vertical position of the near measuring point or the point where full addition is reached (typically, whichever length is the shorter of the two).

According to an aspect of the invention, the progressive lens of the present invention can exhibit one or more of the following characteristics: a “V-shaped” cylinder map, a relatively low position of maximum gradient of power progression, and/or a large vertical separation between vertical position of maximal cylinder and vertical position of maximum gradient of power progression. Aspects of these features are described below with reference to the Figures.

“V-shaped” Cylinder Map:

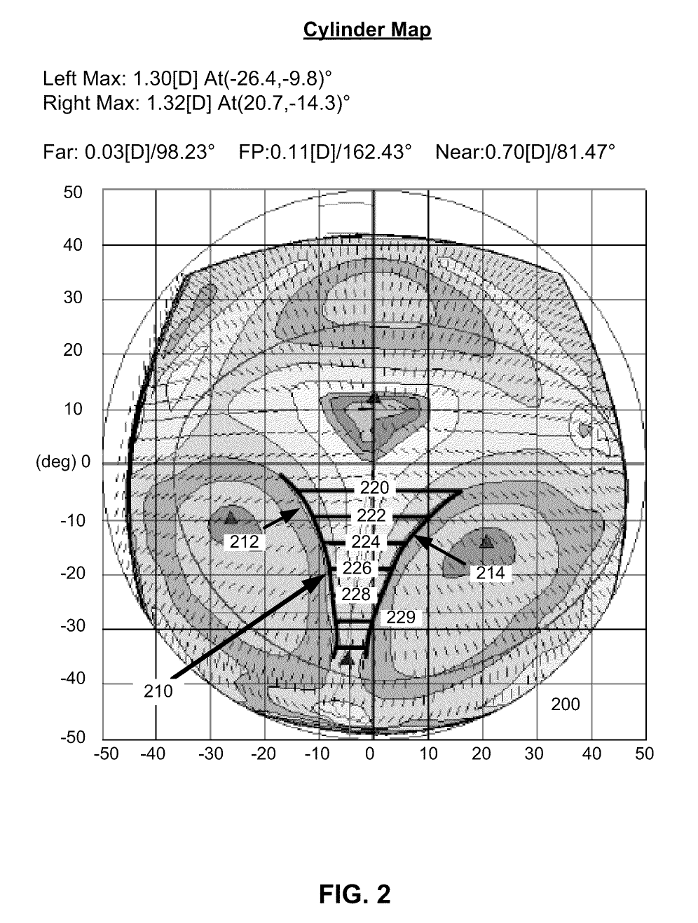

As shown in the cylinder map 200 of FIG. 2, the corridor width 210, shown generally in the bold ladder-shaped lines 220-229 and boundaries 212, 214, of the progressive lens of the present invention can form a generally V-shape. For example, the corridor width 220-229 of the progressive lens of the present invention can monotonically decrease along the corridor between the fitting point of the lens and the end of corridor. Thus, as shown in FIG. 2, the corridor width 210 of the progressive lens of the present invention can form a “v-shape” as one moves down the corridor from the fitting point to the area of maximum add power. For example, the corridor width 220 may extend approximately from −15 degrees to 15 degrees, corridor width 222 may extend approximately from −12 degrees to 10 degrees, corridor width 224 may extend approximately from −10 degrees to 5 degrees, corridor width 226 may extend approximately from −8 degrees to 4 degrees, corridor width 228 may extend approximately from −7 degrees to 2 degrees, corridor width 229 may extend approximately from −6 degrees to 0 degrees, etc.

Other relevant specifications of the exemplary cylinder map shown in FIG. 2 are listed below:

### Left Max: 1.30[D] At(−26.4,−9.8)°

### Right Max: 1.32[D] At(20.7,−14.3)°

### Far: 0.03[D]/98.23°

### FP:0.11[D]/162.43°

### Near:0.70[D]/81.47°

Low Position of Maximum Gradient of Power Progression:

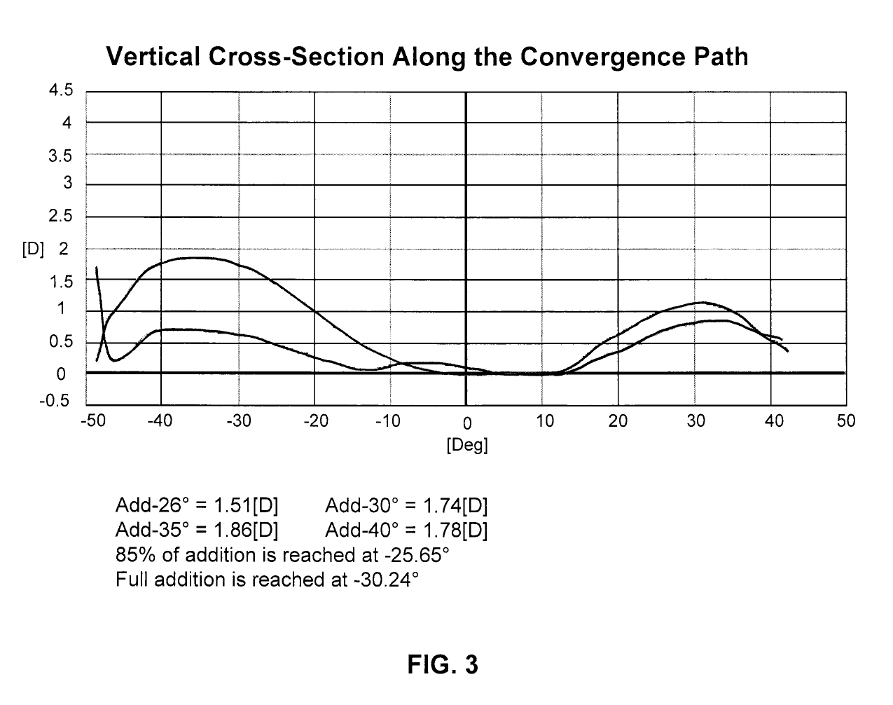

According to other aspects of the present invention, exemplary progressive lenses may provide a maximum gradient of power progression along the corridor that is located within a lower portion, e.g. the lowest third, of the corridor length. FIG. 3 shows an exemplary graph with a add power plotted with respect to vertical position. As shown in FIG. 3, an exemplary lens with the following characteristics may be provided:

### Add-26°=1.51 [D]

### Add-30°=1.74[D]

### Add-35°=1.86[D]

### Add-40°=1.78[D]

85% of addition is reached at −25.65°
Full addition is reached at −30.24
Corridor length=30 deg

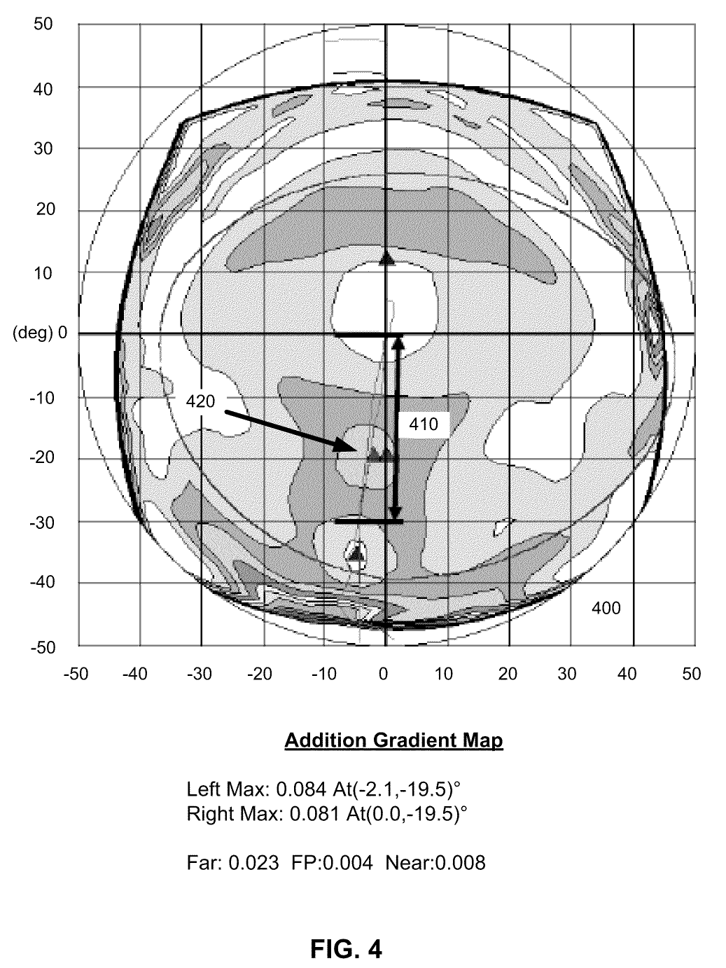

As shown in the addition gradient map of FIG. 4, the exemplary lens may include a corridor length 410 with a length of approximately 30 degrees. As also shown in FIG. 4, the maximum gradient 420 of power progression may be located at approximately 20 degrees from the top of the corridor. Accordingly, the maximum gradient of power progression is located within the lower half, specifically the lowest third, of the corridor, i.e., between 20 and 30 degrees of the corridor length of 30 degrees.

Large vertical separation between vertical position of maximal cylinder and vertical position of maximum gradient of power progression:

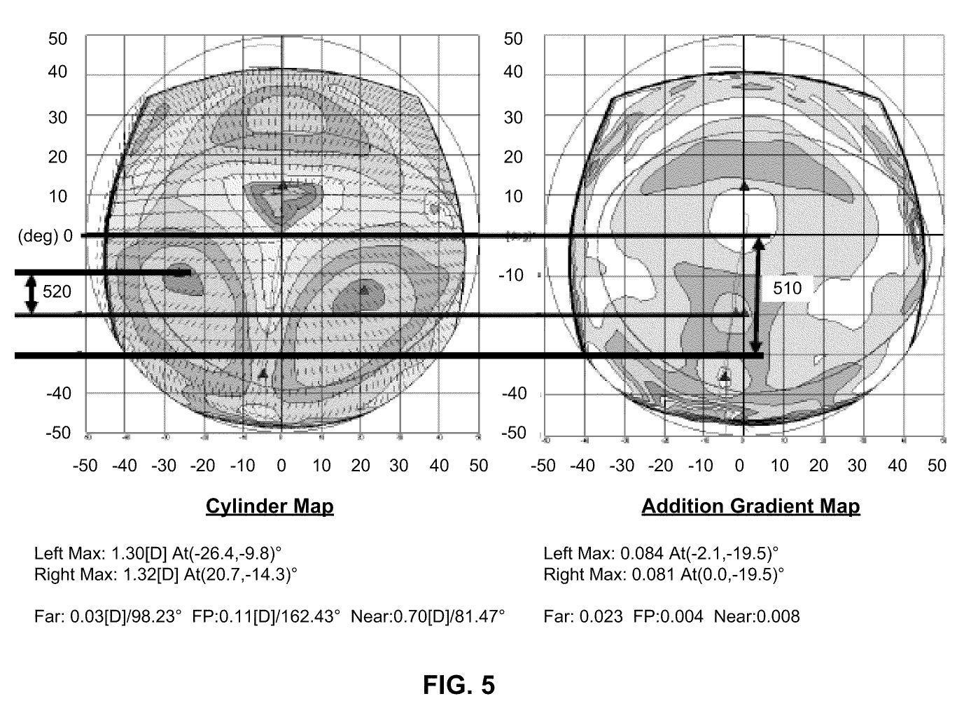

According to yet further aspects of the present invention, the progressive lens of the present invention can provided a relatively large separation between the maximum cylindrical astigmatism and the maximum gradient of power progression. FIG. 5 depicts a comparison between a cylinder map of the lens and an addition gradient map of the lens. As shown in FIG. 5, a corridor length 510 includes a length between a fitting point (0 degrees) and a vertical position of a point where full addition is reached. The vertical separation 520, on left or right side of the lens, between the position of maximum astigmatism and the position of maximum gradient of power progression is greater than 20%, i.e. approximately a third, of the corridor length of the lens. Specifically, the corridor length 510 is approximately 30 degrees in length while the separation 520 vertically between the point of maximum astigmatism and point of maximum gradient of power progression is approximately 10 degrees in length.

The description given above is merely illustrative and is not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments.

What is claimed is:

1. A progressive lens comprising:
a progressive add zone; and
a corridor width including a horizontal length between two points at the same vertical position where the cylinder astigmatism is approximately 0.75 D;
wherein, a cylinder map of the lens includes a plurality of vertically separated corridor widths forming a substantially v-shaped corridor between the cylinder astigmatism of approximately 0.75 D.

2. The lens of claim 1, wherein the v-shaped corridor is in a lower 50% of the lens.

3. The lens of claim 2, wherein the corridor widths of the v-shaped corridor include at least a first width extending approximately from −10 degrees to 10 degrees, and a second width extending approximately from −6 degrees to 0 degrees, on the cylinder map.

4. A progressive lens comprising:
a progressive add zone;
a corridor length including a length between a fitting point and a vertical position of at least one of a near measuring point and a point where full addition is reached;
wherein, an addition gradient map of the lens includes a maximum gradient of power progression in a lower half of a corridor length.

5. The lens of claim 4, wherein the maximum gradient of power progression is in a lower third of the corridor length.

6. The lens of claim 4, wherein the corridor length is approximately 30 degrees and the maximum gradient of power progression is located at approximately 20 degrees below the fitting point.

7. A progressive lens comprising:
a progressive add zone;
a corridor length including a length between a fitting point and a vertical position of at least one of a near measuring point and a point where full addition is reached;
wherein, a comparison between a cylinder map of the lens and an addition gradient map of the lens indicates a vertical separation between a vertical position of maximal cylinder and a vertical position of maximum gradient of power progression, the vertical separation being greater than 20% of the corridor length.

8. The lens of claim 7, wherein the vertical separation is approximately 30% of the corridor length.

9. The lens of claim 8, wherein the corridor length is approximately 30 degrees and the vertical separation is approximately 10 degrees.
